(19) United States
(12) Patent Application Publication
(10) Pub. No.: US 2010/0298078 A1
(43) Pub. Date: Nov. 25, 2010

(54) RATCHET-TYPE TENSIONER

(75) Inventors: Manabu Hirayama, Osaka (JP); Takahiro Matsushita, Osaka (JP); Katsuya Nakakubo, Osaka (JP); Yuji Kurematsu, Osaka (JP); Osamu Yoshida, Osaka (JP); Shintarou Yoshimoto, Osaka (JP)

Correspondence Address: HOWSON & HOWSON LLP, 501 OFFICE CENTER DRIVE, SUITE 210, FORT WASHINGTON, PA, 19034, US

(73) Assignee: Tsubakimoto Chain Co., Osaka (JP)

(21) Appl. No.: 12/770,871

(22) Filed: Apr. 30, 2010

(30) Foreign Application Priority Data
May 20, 2009 (JP) 2009121762

(51) Int. Cl. F16H 7/08

(52) U.S. Cl. 474/110

(57) ABSTRACT

In a ratchet tensioner, a linearly moving ratchet for engagement with rack teeth on a plunger is operated a piston that is spring-biased in a direction to engage the ratchet teeth with the rack, and movable by oil pressure in a direction to disengage the ratchet teeth from the rack. The piston is located within a hole in the housing and, with that hole, forms a second high pressure oil chamber that can receive oil through an oil supply path independent of the oil supply path that carries oil to a first high pressure oil chamber formed by the plunger and the tensioner housing.

### CROSS REFERENCE TO RELATED APPLICATIONS

This application claims priority under Title 35, United States Code, §119 (a)-(d) on the basis of Japanese Patent Application No. 2009-121762, filed on May 20, 2009. The disclosure of Japanese Patent Application No. 2009-121762 is herein incorporated by reference in its entirety.

### FIELD OF THE INVENTION

This invention relates to a ratchet tensioner for applying a tensioning force to a timing chain for driving an engine camshaft and, optionally, other engine components.

### BACKGROUND OF THE INVENTION

It is known to apply tension to a timing chain by means of a tensioner having a plunger slidable in the plunger-accommodating hole of a tensioner housing. The plunger and housing cooperate to form a high pressure oil chamber, and the plunger is urged in a direction to exert a tensioning force on the timing chain by a plunger-biasing spring and also by hydraulic pressure applied from an external pressure source to the oil in the oil chamber.

FIG. 7 illustrates a prior art tensioner 500 having a piston 526 incorporated into a tensioner housing 512 for movement in a direction orthogonal to the direction in which a plunger 514 slides. The piston 526 and the housing form a second oil chamber 520 which receives oil from an oil passage 544. An air chamber 528 is formed in the housing 512 on the side of piston 526 opposite from the second oil chamber 520. Within this air chamber, a second spring 534 biases the piston 526 toward the second oil chamber 520. An air communication hole 532 connects air chamber 528 to the external atmosphere. The air communication hole 532 can be closed by an end of piston rod 524 when the piston 526 moves against the biasing force exerted by spring 534 as a result of pressure applied to the piston 526 by the oil in the second oil chamber 520. A toothed rack 538 is engageable by teeth 536 formed at the end of the piston rod 524 to block retracting movement of the plunger 514. The tensioner of FIG. 7 is described in Japanese Utility Model No. 2559664.

In the above-described prior art tensioner 500, the main high pressure oil chamber 516 in which hydraulic pressure is applied to the plunger 514, and the second oil chamber 520 for applying hydraulic pressure to the piston 526, are connected by oil passage 548 and an oil passage 544, which are branches of an oil path connected to an oil reservoir 550. If the engine in which the tensioner is installed is inoperative for a long period of time, air enters the second chamber 520. As a result, the hydraulic pressure in the second oil chamber 520 may not be sufficient to cause disengagement of teeth 536 on rod 524 from the rack 538 on plunger 514. It is possible that the engagement of the teeth 526 from the rack 538 will not be released completely and quickly. Accordingly, in the tensioner 500, smooth forward and backward movement of the plunger 514 may not be achieved promptly after starting of the engine. Teeth 536 on the piston rod 524 or the teeth of rack 538 may be broken, with the result that the biasing force of the plunger 514 may not adequately compensate for elongation of the transmission chain. Moreover, abnormal noises caused by the flapping of the timing chain cannot be eliminated by completely blocking backlash of the plunger 514 as a result of forces received from the timing chain.

The prior art tensioner 500 also requires a tough plunger-biasing spring 518 to sustain backlash of the plunger 514, and, as a result, the size of the tensioner is increased.

### SUMMARY OF THE INVENTION

The ratchet tensioner according to the invention comprises a housing having a plunger-accommodating hole with an end opening and a bottom. A first oil supply passage is provided for introduction of oil under pressure into the plunger-accommodating hole. A plunger for maintaining tension in a traveling transmission chain is slidable in the plunger-accommodating hole, and protrudes from the end opening of the plunger-accommodating hole. The plunger is hollow and has an elongated toothed rack formed on its external surface. The toothed rack extends along the protruding direction of the plunger and has a series of teeth arranged in succession along the protruding direction. A plunger-biasing spring for biasing the plunger in its protruding direction is disposed in a first high-pressure oil chamber formed by the plunger-accommodating hole and the hollow portion of the plunger. a check valve unit is assembled at the bottom of the plunger-accommodating hole to block reverse flow of oil from the first high-pressure oil chamber to the first oil supply passage. A cylindrical piston-accommodating hole is also provided in the housing. The piston-accommodating hole has an axis extending in a direction transverse to the protruding direction of the plunger. A piston, slidable in the piston-accommodating hole along its axis, has at least one ratchet tooth engageable with the toothed rack on the plunger. A piston-biasing spring biases the piston toward the toothed rack so that at least one ratchet tooth can engage the toothed rack on the plunger. The least one ratchet tooth and the teeth of the toothed rack are shaped to permit displacement of the plunger in its protruding direction and to block retracting displacement of the plunger in the direction opposite to the protruding direction. The tensioner further comprises a second high-pressure oil chamber formed by the piston and the piston-accommodating hole, and located between the piston and the plunger, for receiving oil under pressure and thereby displacing the piston in a direction to release engagement of the at least one ratchet tooth from the rack teeth on the plunger against the biasing force of the plunger-biasing spring. A second oil supply passage is provided for introducing oil under pressure into the second high-pressure oil chamber. The second oil supply passage is isolated from the first oil supply passage sufficiently that the oil pressure in the second oil supply passage can be different from the pressure in the first oil supply passage.

Because the biasing force of the plunger-biasing spring acts on the piston, the tensioner permits forward displacement of the plunger but blocks backward displacement, thereby suppressing backlash and flapping noises generated by the timing chain causing backlash.

After the engine is started, oil pressure in the second high pressure oil chamber releases the engagement of the ratchet teeth with the rack teeth on the plunger, permitting smooth forward and backward movement of the plunger. It is possible to adjust the timing of disengagement of the ratchet by adjusting the biasing force of the piston-biasing spring.

After starting of the engine following an extended inoperative interval, when hydraulic pressure within the second high-pressure oil chamber increases, and the force imparted by the hydraulic pressure to the piston exceeds the force exerted by the piston-biasing spring, the ratchet tooth or teeth are disengaged from the rack teeth without skipping, and forward and backward movement of the plunger can take place.

In some embodiments of the invention, the second oil supply passage formed in the housing is arranged to supply oil to the second high pressure oil chamber directly. In this case, the second oil supply passage is independent of the first oil supply passage and the pressure of oil in the second high pressure oil chamber is independent of the pressure of the oil in the first high pressure oil chamber.

Where the second oil supply passage is independent of the first oil supply passage, i.e., neither passage is a branch of the other it is possible for the second high-pressure oil chamber to avoid being directly influenced by pulsation in pressure of the oil introduced into the first oil supplying passage, even when the capacity of the second high-pressure oil chamber is smaller than that of the first high-pressure oil chamber. As a result, stable generation of hydraulic pressure within the second high pressure oil chamber takes place, and it becomes possible to achieve quick forward and backward movement of the plunger smoothly.

Another advantage of independent oil supply passages is that the second oil supply passage can be disposed at any convenient position in the tensioner housing, oil can be introduced into the second high-pressure oil chamber through a short path, and fabrication of the second oil supply passage can be simplified.

The second oil supply passage can be provided with an orifice for absorbing pulsation in the pressure of the oil introduced into the second high pressure oil chamber through the second oil supply passage of the external pressure oil. The orifice suppresses the amount of oil introduced into the second high-pressure oil chamber through the second oil supply passage when it the supply of oil is excessive, and also suppresses leakage of oil from the high-pressure oil chamber when the oil supply is insufficient. Accordingly, with the orifice in place, the effect of pulsations on the ratchet mechanism can be avoided, and a stable supply of oil to the second oil chamber can be ensured.

In other embodiments of the invention, the second oil supply passage directly connects the second high pressure oil chamber to the first high-pressure oil chamber. Even so, because the check valve, at least when closed, isolates the oil supply paths from each other, the pressures in the oil supply paths can be different. These embodiments have the advantage that the ratchet piston is actuated in synchronism with pulsations in the high-pressure oil chamber. Accordingly, the ratchet tensioner instantly releases the ratchet tooth or teeth from the rack teeth after starting of the engine, and permits smooth forward and backward movements of the plunger.

In certain preferred embodiments, a projection extends from the piston to the exterior of the housing, the projection being manually accessible outside the housing for forcibly releasing engagement of the at least one ratchet tooth from the toothed rack to permit retracing movement of the plunger. Manual release of the ratchet mechanism simplified tensioner installation and engine maintenance.

### BRIEF DESCRIPTION OF THE DRAWINGS

FIG. 1 is a schematic elevational view of an engine timing transmission incorporating a ratchet tensioner according to the invention;

FIG. 2 is a section view of the ratchet tensioner shown in FIG. 1;

FIG. 3 is a side view of the ratchet tensioner shown in FIG. 1;

FIG. 4 is a section view showing a state of engagement of a ratchet and a plunger;

FIG. 5 is a section view showing a state in which the engagement of the ratchet and the plunger is released;

FIG. 6 is a section view of the ratchet tensioner according to a second embodiment of the invention; and

FIG. 7 is a section view of a prior art ratchet tensioner.

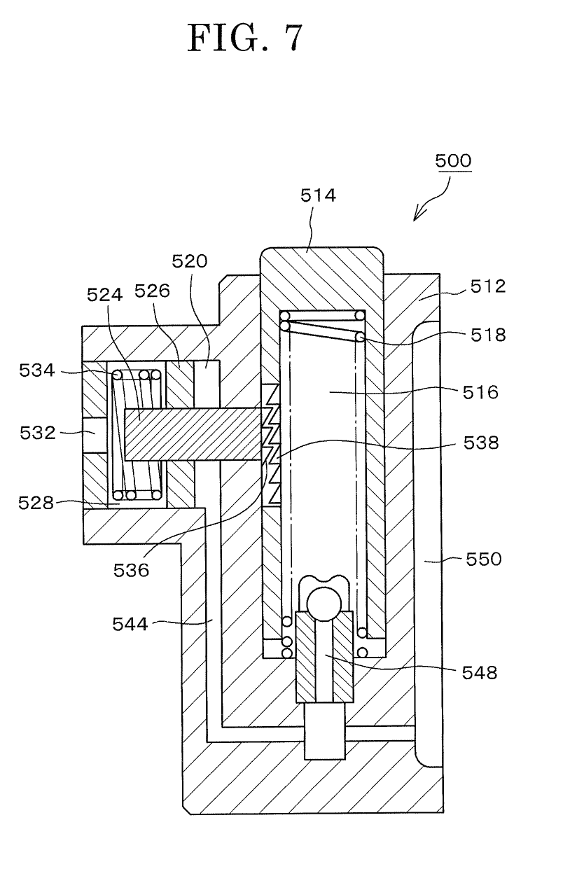

### DETAILED DESCRIPTION OF THE PREFERRED EMBODIMENTS

The advantages of the invention can be realized in various embodiments, provided that they comprise a housing having a plunger-accommodating hole, a first oil supply passage for introduction of oil under pressure into the plunger-accommodating hole, a hollow plunger slidable in the plunger-accommodating hole, and protruding from an end opening thereof, an elongated toothed rack formed on the external surface of the plunger and extending along the protruding direction of the plunger with a series of teeth arranged in succession along the protruding direction, a plunger-biasing spring biasing the plunger in its protruding direction and disposed in a first high-pressure oil chamber formed by the plunger-accommodating hole and the hollow portion of the plunger, a check valve unit at the bottom of the plunger-accommodating hole to block reverse flow of oil, a cylindrical piston-accommodating hole having an axis extending in a direction transverse to the protruding direction of the plunger, a piston slidable in the piston-accommodating hole along its axis, a piston-biasing spring biasing the piston toward the toothed rack, at least one ratchet tooth on the piston and engageable with the toothed rack on the plunger, the teeth being shaped to permit displacement of the plunger in its protruding direction and to block retracting displacement of the plunger in the direction opposite to the protruding direction, a second high-pressure oil chamber formed by the piston and the piston-accommodating hole, and located between the piston and the plunger, for receiving oil under pressure and thereby displacing the piston in a direction to release engagement of the at least one ratchet tooth from the rack teeth against the biasing force of the plunger-biasing spring, and a second oil supply passage for introducing oil under pressure into the second high-pressure oil chamber, and the oil supply passages are isolated from each other sufficiently that the oil pressures in the oil supply passages can be different.

The ratchet tensioner blocks backlash of the plunger due to force receiving from the timing chain on starting the engine, when the engine has been inoperative for an extended interval, and generates hydraulic pressure stably within the second high-pressure oil chamber to achieve quick forward and backward movement of the plunger smoothly.

Oil supplied from an oil pump can be introduced directly into the first oil supply passage in the housing or can be introduced through an oil reservoir formed on a back of the housing for temporarily storing oil supplied from the oil pump before introducing it into the first oil supply passage.

The check valve unit used in the ratchet tensioner of the invention can be any of various check valve types as long as it is assembled at the bottom of the plunger-accommodating hole and blocks reverse flow of the oil from the high-pressure oil chamber to the first oil supply passage. For example, the check valve unit may have a ball seat that communicates with the first oil supply passage and supplies oil under pressure to the high-pressure oil chamber, a check ball that faces a seating surface of the ball seat, a ball-biasing spring for pressing and biasing the check ball against the ball seat, and a bell-like retainer for restricting displacement of the check ball.

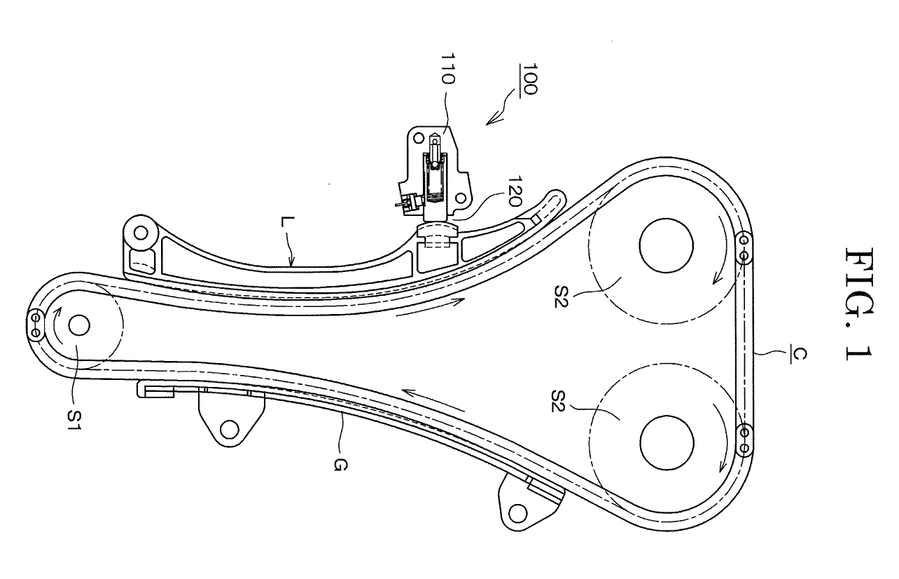

As shown in FIG. 1, the ratchet tensioner 100 according to a first embodiment of the invention is attached to an engine adjacent the slack side of a timing chain C that is in meshing engagement with a driving sprocket S1 on an engine crankshaft and one or more driven sprockets S2 on the engine camshafts. A plunger 120 of the tensioner protrudes from the tensioner housing 110, and applies tension to the slack side of the timing chain C through a movable lever L pivotably supported on the engine block by pressing against the back of the lever L at a location spaced from the lever's pivot axis.

A stationary guide G for guiding the travel of the timing chain C is fixed on the engine block adjacent the tension side of the timing chain C.

Rotation of the crankshaft sprocket S1 is transferred by the timing chain to the camshaft sprockets S2. The directions of rotation of the sprockets, and the direction of movement of the timing chain, are indicated by arrows in FIG. 1. that

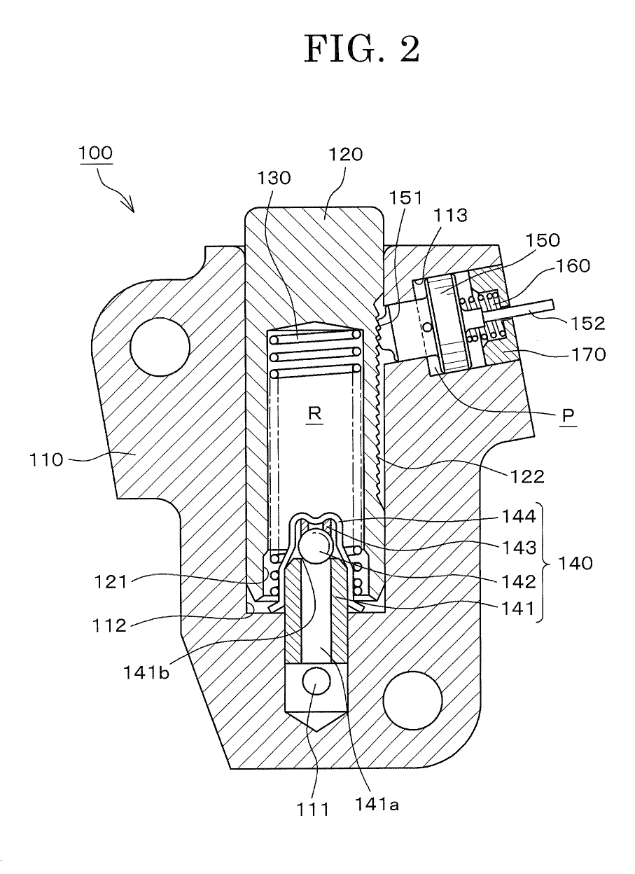

As shown in FIG. 2, the housing 110 of tensioner 100 has a first oil supply passage 111 for introducing oil supplied under pressure from the engine block (not shown) to which the tensioner housing is attached. Hollow plunger 120 is slidable in a plunger-accommodating hole 112 in the housing, and protrudes outward from the housing toward the chain as shown in FIG. 1. A plunger-biasing spring 130 is disposed in a high-pressure oil chamber R formed by the plunger-accommodating hole 112 and the hollow interior 121 of the plunger. The spring 130 biases the plunger in the protruding direction.

A check valve unit 140, assembled at the bottom of the plunger-accommodating hole 112a, blocks reverse flow of oil from the high-pressure oil chamber R to the first oil supply passage 111. A piston 150 having a set of ratchet teeth 151 fits in a cylindrical hole 113 formed in the housing 110, and is slidable in a direction transverse to the direction in which the plunger 120 moves. A plunger-biasing spring 160 urges the piston 150 in a direction such that its ratchet teeth 151 can engage with a toothed rack 122 formed on the plunger and extending longitudinally on a side of the plunger. The rack teeth are arranged as a series of teeth in succession along said protruding direction of the plunger.

Although the axis of the piston-accommodating hole 113 is slightly oblique with respect to the direction of protrusion of the plunger, the hole 113 can be configured in any direction transverse to the protruding direction of the plunger as long the teeth 151 can engage and disengage the rack teeth as a result of movement of the piston in the piston-accommodating hole. A retaining plug 170 retains the piston 150 and the piston-biasing spring 160 within the piston-accommodating hole 113.

Any of various known check valve units can be used as long as it is located at the bottom of the plunger-accommodating hole 112 and is capable of blocking reverse flow of oil from the high-pressure oil chamber R to the first oil supply passage 111. In the embodiment shown, the check valve unit 140 is composed of a ball seat 141 having an oil passage 141a connected to the first oil supply passage 111, a check ball 142 seated on a valve seat 141b formed at an end of ball seat 141, a ball-biasing spring 143 for pressing and biasing the check ball 142 against the ball seat 141, and a bell-shaped retainer 144 for supporting the ball biasing spring 143 and restricting displacement of the check ball 142.

A second high-pressure oil chamber P is formed by the piston 150 and the piston-accommodating hole 113. Oil pressure in the chamber P exerts a force of the piston opposing the biasing force exerted by spring 160. When the force on the piston resulting from hydraulic pressure within oil chamber P exceeds the biasing force exerted by spring 160, after starting of the engine, when the engine has been inoperative for a long interval, the ratchet teeth 151 are pulled away from the rack teeth by displacement of the piston 150, thereby releasing the ratchet without skipping the rack teeth 122 on the plunger, and forward and backward movement of the plunger 120 can then take place without restriction by the ratchet mechanism.

Oil is supplied to the second high pressure oil chamber P through a second oil supply passage 114. Passage 114 in this embodiment is independent of, and not a branch of, the first oil supply passage 111. Passage 114 is formed in housing 110 and configured to introduce oil under pressure into chamber P directly from an oil port in the engine block without significant influence by pulsations of pressure in the oil introduced into the first high pressure oil chamber R through the first oil supply passage 111. The independent supply of oil to the second oil chamber P avoids excessive response by the piston 150 to variations in pressure in chamber R that could occur in the case of direct communication between chambers P and R, especially if the capacity of chamber P is much smaller than the capacity of the chamber R. Thus, it is possible to achieve quick forward and backward movement of the plunger 120 by generating hydraulic pressure within the second high-pressure oil chamber P in a stable manner, so that forward and backward movement of the plunger 120 is permitted after starting of the engine.

Because the second oil supply passage 114 can be disposed at any of various positions in the housing irrespective of the location of the first oil supply passage 111, oil can be introduced into the second high-pressure oil chamber P through a short passage, and the short passage can be formed easily.

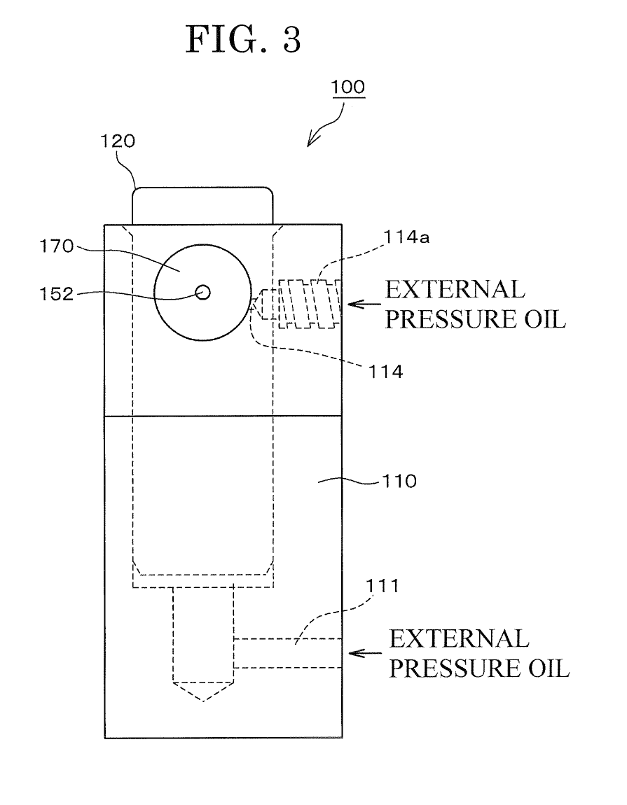

The second oil supply passage 114 described can be provided with a restricted orifice 114a as shown in FIG. 3. The orifice absorbs pulsation in the oil supplied under pressure from the engine block that result from operation of the engine oil pump. The orifice 114a also suppresses the amount of the oil introduced under pressure into the second high-pressure oil chamber P through the second oil supply passage 114 when it the oil supply is excessive, and suppresses leakage of oil from chamber P when the oil supply is insufficient. Thus, the ratchet tensioner 100 ensures a stable supply of oil under pressure to the second high pressure oil chamber P.

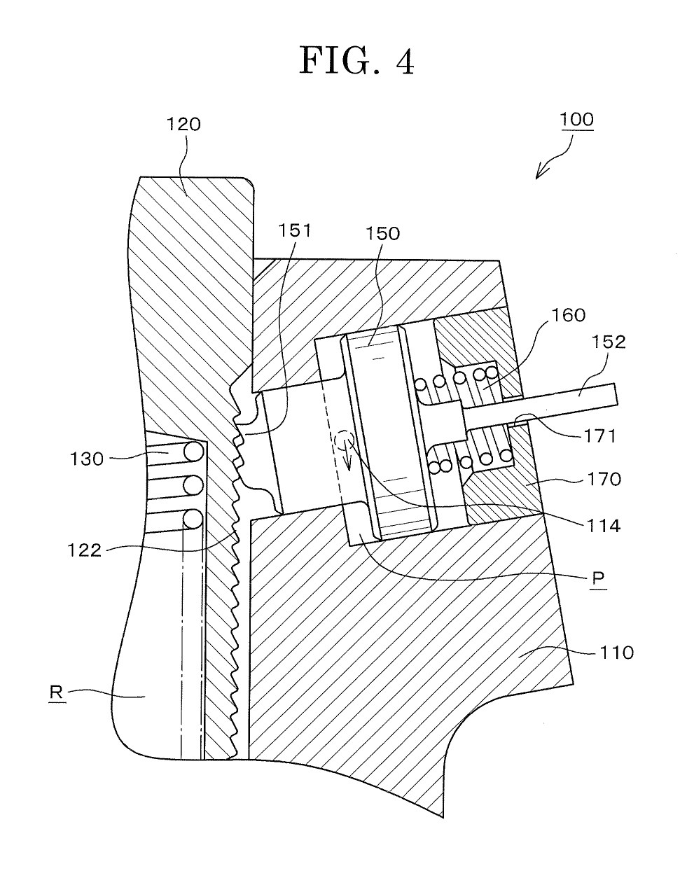

A ratchet-releasing projection 152 is provided on the rear part of the piston 150 as shown in FIGS. 2 and 4. This projection extends through a hole 171 in the retaining plug 170, and can be grasped manually from the outside of the housing 110. When pulled, projection 152 releases the engagement of teeth 151 with rack teeth 122 on the plunger 120, so that the plunger can move forward or backward as necessary when the tensioner is being attached to the engine block and when and various maintenance operations are carried out.

In the operation of the tensioner 100 described above, at first, while the engine is stopped, and on starting the engine, no oil is supplied from the engine block through the second oil supply passage 114, and the force exerted on piston 150 by hydraulic pressure within the second high-pressure oil chamber P is smaller than the biasing force exerted by piston biasing spring 160. The ratchet teeth 151 are held engaged with the rack teeth 122 on the plunger by the biasing force of the piston biasing spring 160 as shown in FIG. 4, and block backlash of the plunger 120 which would otherwise occur due to forces exerted by the timing chain.

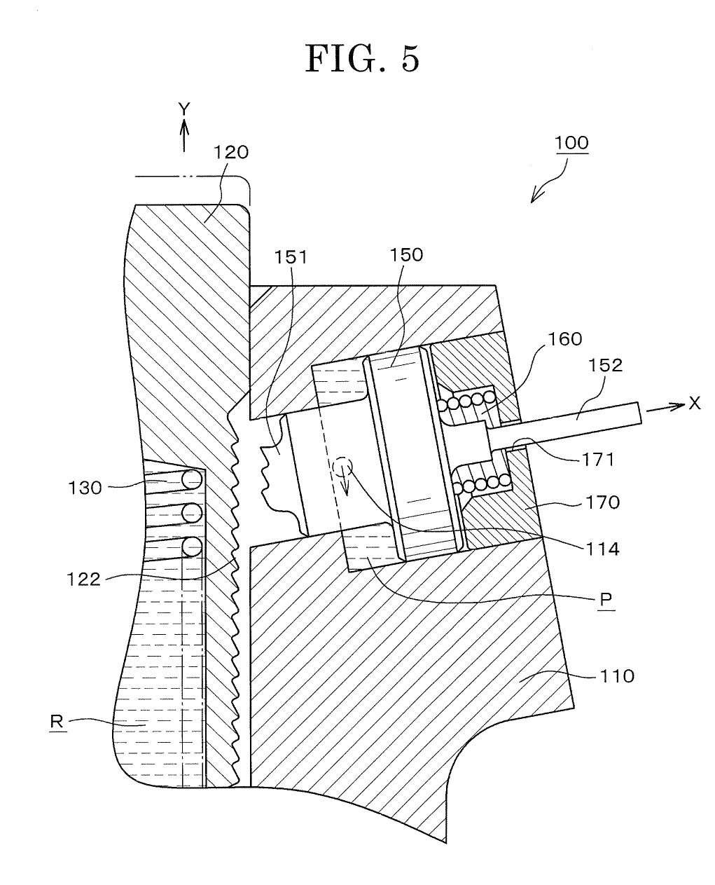

After the engine is started, oil is supplied under pressure from the engine block through the second oil supply passage 114 and the oil pressure in chamber P causes the piston 150 to move, as shown in FIG. 5, in a direction X against the biasing force exerted by spring 160, withdrawing the ratchet teeth 151 from the rack teeth 122 on the plunger without skip. Hydraulic pressure is generated in a stable manner within the second high-pressure oil chamber P allowing forward and backward movements of the plunger 120 along direction Y to take place smoothly.

When the orifice 114a is in place to absorb pulsation in the oil supplied directly to the second high-pressure oil chamber P, the tensioner suppresses flapping noises produced by the timing chain on starting of the engine, especially when the engine has been inoperative for a long interval. The flapping noises are suppressed by permitting forward displacement while blocking backward displacement of the plunger 120. After engine start-up, the ratchet teeth 151 are disengaged from the rack teeth 122 so that the plunger can move both forward and backward.

The time at which the ratchet teeth are disengaged from the rack teeth after engine start-up can be adjusted by adjusting the biasing force of the piston-biasing spring 160. Moreover, as mentioned previously installation and maintenance of the tensioner are simplified by the provision of the piston releasing projection 152.

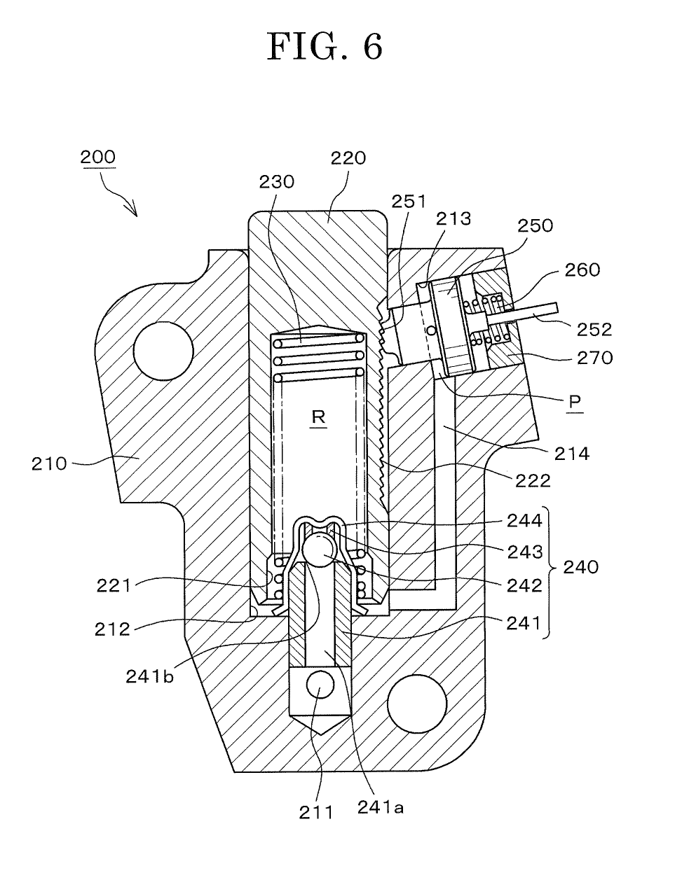

FIG. 6 shows another version of the ratchet tensioner of the invention, in which the first and second high pressure oil chambers are connected. Parts of the tensioner of FIG. 6 that are identical to parts of the tensioner of FIGS. 1-5 are designated by reference numbers that exceed the reference numbers of the corresponding parts by 100.

The ratchet tensioner 200 shown in FIG. 6 is also attached to an engine block, and associated with a timing chain, in the same manner as illustrated in FIG. 1.

The ratchet tensioner 200 differs from ratchet tensioner 100 primarily in the position and configuration of the second oil supply passage 214 for introducing oil under pressure into the second high-pressure oil chamber P.

The second oil supply passage 214 is formed in the housing 210 and is independent of the first oil supply passage 211 in that it is connected directly to first high pressure oil chamber R, whereas passage 211 is connected to chamber R through the check valve unit. The second oil supply passage 214 is connected to the first high-pressure oil chamber R near the bottom of the plunger-accommodating hole 212, and delivers oil from chamber R into the second high-pressure oil chamber P.

Even if the hydraulic pressure in the second high-pressure oil chamber P receives pulsations from the high-pressure oil chamber R, the piston 250 acts in synchronism with these pulsations so that the engagement of ratchet teeth 251 with the rack teeth 222 is released instantly, and smooth forward and backward movement of the plunger 220 can commence after starting of the engine.

As in the case of the first embodiment, the ratchet tensioner 200 suppresses flapping noise of the timing chain that can take place at the time of engine start-up especially when the engine is started after being inoperative for a long interval. The flapping noise is suppressed by permitting forward displacement while blocking backward displacement of the plunger 220 on engine start-up.

Since the tensioner 200 releases the engagement of the ratchet teeth 251 from the rack teeth 222 on the plunger by actuating piston 250 in synchronism with the pulsations in the high-pressure oil chamber R, it permits smooth forward and backward movement of the plunger 220 after engine start-up.

As in the first embodiment disengagement timing can be adjusted by adjusting the biasing force exerted by the piston-biasing spring 260, and installation and maintenance of the tensioner can be simplified by provision of a piston releasing projection 252 for manual release of the ratchet.

What is claimed is:

1. A ratchet tensioner comprising:
a housing having a plunger-accommodating hole with an end opening and a bottom;
a first oil supply passage for introduction of oil under pressure into the plunger-accommodating hole;
a plunger having a hollow portion, the plunger being slidable in, and protruding in a protruding direction from the end opening of the plunger-accommodating hole for maintaining tension in a traveling transmission chain, said plunger having an external surface and an elongated toothed rack formed on said external surface, the toothed rack extending along said protruding direction and having a series of teeth arranged in succession along said protruding direction;
a plunger-biasing spring disposed in a first high-pressure oil chamber formed by the plunger-accommodating hole and the hollow portion of the plunger, the spring biasing the plunger in its protruding direction;
a check valve unit assembled at the bottom of said plunger-accommodating hole to block reverse flow of oil from the first high-pressure oil chamber to the first oil supply passage;
a cylindrical piston-accommodating hole in the housing having an axis extending in a direction transverse to the protruding direction of the plunger;
a piston slidable in the piston-accommodating hole along said axis, said piston having at least one ratchet tooth engageable with said toothed rack on the plunger; and
a piston-biasing spring for biasing said piston toward said toothed rack so that its at least one ratchet tooth can engage the toothed rack on the plunger;
said at least one ratchet tooth and the teeth of said toothed rack being shaped to permit displacement of the plunger in its protruding direction and to block retracting displacement of the plunger in the direction opposite to said protruding direction:
the tensioner further comprising a second high-pressure oil chamber formed by the piston and the piston-accommodating hole, and located between the piston and the plunger, for receiving oil under pressure and thereby displacing the piston in a direction to release engagement of the at least one ratchet tooth from the rack teeth on the plunger against the biasing force of said plunger-biasing spring; and
a second oil supply passage for introducing oil under pressure into said second high-pressure oil chamber;
wherein the second oil supply passage is isolated from the first oil supply passage sufficiently that the oil pressure in the second oil supply passage can be different from the pressure in the first oil supply passage.

2. The ratchet tensioner according to claim 1, wherein the second oil supply passage is formed in the housing, and is arranged to supply oil to the second high pressure oil chamber directly, the second oil supply passage being independent of the first oil supply passage whereby the pressure of oil in the second high pressure oil chamber is independent of the pressure of the oil in the first high pressure oil chamber.

3. The ratchet tensioner according to claim 2, wherein said second oil supply passage is provided with an orifice for absorbing pulsation in the pressure of oil introduced into the second high pressure oil chamber through the second oil supply passage of the external oil under pressure.

4. The ratchet tensioner according to claim 1, wherein said second oil supply passage is formed in said housing, and directly connects the second high pressure oil chamber to the first high-pressure oil chamber.

5. The ratchet tensioner according to claim 1, further comprising a projection extending from said piston to the exterior of the housing, the projection being manually accessible outside the housing for forcibly releasing engagement of the at least one ratchet tooth from the toothed rack to permit retracing movements of the plunger.

6. The ratchet tensioner according to claim 2, further comprising a projection extending from said piston to the exterior of the housing, the projection being manually accessible outside the housing for forcibly releasing engagement of the at least one ratchet tooth from the toothed rack to permit retracing movements of the plunger.

7. The ratchet tensioner according to claim 3, further comprising a projection extending from said piston to the exterior of the housing, the projection being manually accessible outside the housing for forcibly releasing engagement of the at least one ratchet tooth from the toothed rack to permit retracing movements of the plunger.

8. The ratchet tensioner according to claim 4, further comprising a projection extending from said piston to the exterior of the housing, the projection being manually accessible outside the housing for forcibly releasing engagement of the at least one ratchet tooth from the toothed rack to permit retracing movement of the plunger.
